(19) United States
(12) Patent Application Publication
(10) Pub. No.: US 2002/0051603 A1
(43) Pub. Date: May 2, 2002

(54) Free-space and integrated add-drop optical modules for optical wavelength-division multiplexed systems

(76) Inventors: Roger A. Hajjar, San Jose, CA (US); Scot C. Fairchild, Santa Clara, CA (US)

Correspondence Address: BING AI, Fish & Richardson P.C., Suite 500, 4350 La Jolla Village Drive, San Diego, CA, 92122, US

(21) Appl. No.: 09/829,815

(22) Filed: Apr. 9, 2001

Related U.S. Application Data
(60) Provisional application No. 60/241,728, filed on Oct. 18, 2000.
(60) Provisional application No. 60/260,656, filed on Jan. 9, 2001.
(60) Provisional application No. 60/275,247, filed on Mar. 12, 2001.

(51) Int. Cl. G02B 6/28

(52) U.S. Cl. 385/24; 385/14; 385/140

(57) ABSTRACT

Techniques and devices for using two or more optical bandpass filters in a free-space, integrated package to add, drop, or exchange a WDM channel.

This application claims the benefits of U.S. Provisional Application Nos. 60/241,728 filed on Oct. 18, 2000, entitled INTEGRATED OPTICAL ADD-DROP DEVICE, 60/260,656 filed on Jan. 9, 2001, entitled INTEGRATED OPTICAL ADD-DROP DEVICE, and 60/275,247 filed on Mar. 12, 2001, entitled FREE-SPACE AND INTEGRATED ADD-DROP OPTICAL MODULES FOR OPTICAL WAVELENGTH-DIVISION MULTIPLEXED SYSTEMS.

### BACKGROUND

This application relates to optical wavelength-division multiplexing of optical signals at different wavelengths.

Optical wavelength-division multiplexing (WDM) technique allows for simultaneous transfer of optical signals at different wavelengths, i.e., optical WDM channels, through a single optical link such as an optical fiber. In operation, an optical WDM system may need to add one or more WDM channels to a fiber that already carries one or more other WDM channels, or alternatively, to separate one or more WDM channels from other WDM channels carried by a fiber.

Optical bandpass filters at different WDM wavelengths may be used in various configurations to form WDM multiplexers for adding one or more WDM channels to a fiber, or to form WDM demultiplexers for dropping one or more WDM channels from a fiber. Such a bandpass filter may be designed to transmit light at a selected WDM wavelength while reflecting light at other WDM wavelengths. The functions of adding and dropping an optical WDM channel may be combined in a single WDM module.

### SUMMARY

The techniques and devices of the present disclosure are designed in part to reduce the number of optical elements and to reduce optical loss in a WDM add-drop module. In one embodiment, at least two optical bandpass filters are arranged in free space to process light for adding or dropping a WDM channel. An adjustable optical attenuator may be implemented in an optical path in free space within such a WDM module to adjust the optical power of an added channel.

### BRIEF DESCRIPTION OF THE DRAWINGS

FIG. 1 shows one embodiment of a 4-port WDM add-drop module that uses two optical bandpass filters with the same transmissive center wavelength for adding, dropping, or exchanging a WDM channel.

FIG. 2 shows the reflective and transmissive spectra of the optical bandpass filters used in FIG. 1.

FIG. 3A shows one implementation of the 4-port WDM add-drop module based on the design in FIG. 1.

FIG. 3B shows another implementation of the 4-port WDM add-drop module based on the design in FIG. 1, where two optical reflectors are used to reduce the overall size of the module.

FIGS. 4A and 4B show other implementations of the 4-port WDM add-drop module based on the design in FIG. 1, where one or more optical reflectors are used to reduce the overall size of the module.

FIGS. 5, 6, and 7 show exemplary embodiments of a 4-port WDM add-drop module that uses three optical bandpass filters with the same transmissive center wavelength for adding, dropping, or exchanging a WDM channel.

FIG. 8 shows one exemplary WDM device that uses three different WDM modules at different wavelengths λ₁, λ₂, and λ₃, respectively, to process input WDM channels.

### DETAILED DESCRIPTION

The present disclosure includes WDM add-drop modules that process optical signals in free space internally and use fiber ports to input or output optical signals through optical waveguides such as fibers. Such a WDM add-drop module may be easily coupled to one or more optical fiber devices, fibers, or fiber systems. In addition, the advantages of the low optical loss and the flexibility of the free-space optical configuration may be used to reduce optical loss and save space. Such WDM modules may be generally designed to include at least four fiber ports that are respectively coupled to receive an input optical signal with multiple WDM channels, to drop a WDM channel at a selected wavelength, to add a new WDM channel at the selected wavelength, and to export an output signal that with multiple channels. The output signal may have a void at the channel of the selected wavelength if no new channel at the selected wavelength is added. The output signal may also have a new channel at the selected wavelength for replacing an old input channel at the selected wavelength or filling the void in the input signal.

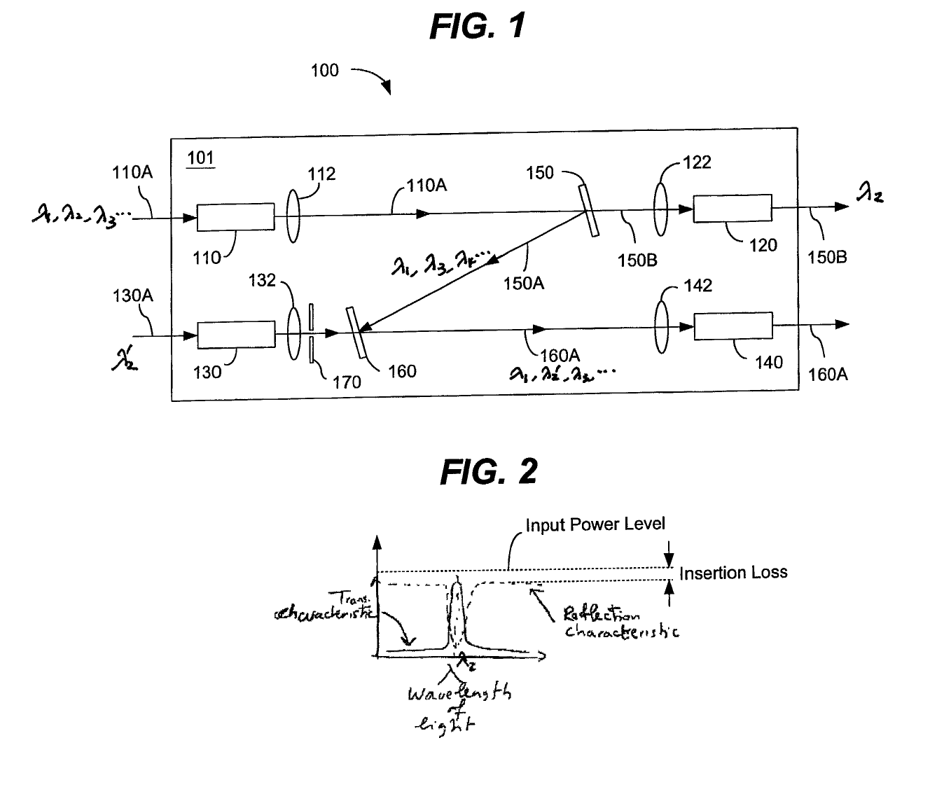

FIG. 1 shows one embodiment of a 4-port WDM add-drop module 100 which includes two optical bandpass filters 150 and 160. A support base 101 is provided to support and hold various elements of the module 100, including, the filters 150 and 160, an input fiber port 110, an output fiber port 140, a drop fiber port 120, and an add fiber port 130. Semiconductor materials, metals, and other suitable solid state materials may be used to form the support base 101. Each fiber port may be a fiber segment or a distal portion of a fiber for receiving or exporting an optical signal. Collimator lenses 112, 122, 132, and 142 are mounted to the base 101 and are respectively positioned at the fiber ports 110, 120, 130, and 140 to couple optical signals into or out of the fiber ports. More specifically, each collimator lens is configured to collimate an output beam from a respective fiber port and to focus a collimated beam incident to the lens into the respective fiber port.

The WDM add-drop module 100 is designed to add, drop, or exchange a WDM channel at a common selected WDM wavelength. The bandpass filters 150 and 160 are designed to transmit light at the common selected center wavelength, e.g., at a wavelength λ₂, with a given transmission bandwidth and to reflect light at other wavelengths. The two opposite surfaces of each filter may be planar surfaces so that the reflective angle of the reflected light is equal to the incident angle of the input light to the filter. FIG. 2 illustrates the reflective and transmissive spectra of the filters 150 and 160. The transmissive bandwidth is sufficiently narrow to transmit one WDM channel while reflecting other WDM channels. Examples for the filters 150 and 160 include, among others, thin-film multi-layer interference filters or Fabry-Perot filters. In general, the transmissive center wavelength of such filters is a function of the incident angle of light, hence, if two filters 150 and 160 are substantially identical in structure, they should be oriented to receive input light at the same incident angle so their transmission center wavelengths are substantially equal.

The input fiber port 110, the lens 112, the filter 150, the lens 122, and the drop fiber port 120 may be arranged on the base 101 along a first common optic axis 101A so that an input optical signal 110A received by the fiber port 110 can be collimated by the lens 112 and directed to the filter 150. If a portion 150B of the signal 110A is at the selected wavelength λ₂, this portion 150B can be received by the lens 122 and focused into the drop fiber port 120 to produce a drop signal 150B. Similarly, the add fiber port 130, the lens 132, the filter 160, the lens 142, and the output fiber port 140 may be arranged on the base 101 along another second common optic axis 101B so that an input optical signal 130A at the selected wavelength λ₂ received by the fiber port 130 can be collimated by the lens 132 and directed to the filter 150 to transmit through the filter 160. The lens 142 receives the transmitted light from the fiber port 130 and focuses it into the output fiber port 140 to produce an output signal 160A.

Notably, the filter 150 is oriented with respect to the first common optical axis so that the remaining portion 150A of the signal 110A at wavelengths other than λ₂ is reflected by the filter 150 to the second filter 160 positioned in the optical path of the second common optical axis 101B. The reflected signal 150A will also be reflected by the filter 160 because it is designed and oriented relative to the filter 150 to transmit light at λ₂ and reflect light at other wavelengths. In particular, the filter 160 is oriented to reflect the beam 150A to propagate along the second common optical axis 101B to be focused by the lens 142 into the output fiber port 140. When the two filters 150 and 160 are identically structured and oriented to receive input beams at the same incident angle, the first and second optical axes 101A and 101B are approximately parallel to each other.

The WDM add-drop module 100 may be controlled to operate as follows. Assume that the input fiber port 110 receives the input signal 110A having WDM channels at different WDM wavelengths λ₁, λ₂, λ₃, . . . , respectively. The signal 110A is then received by the lens 112 and becomes collimated. The filter 150 receives and processes the collimated beam 110A by reflecting the WDM channels at the wavelengths λ₁, λ₃, λ₄, . . . as the reflected beam 150A and transmitting the WDM channel at λ₂ as a transmitted collimated beam 150B to the lens 122. The reflected collimated beam 150A is reflected twice by filters 150 and 160 and is focused into the output fiber port 140 by the lens 142 as an output signal 160A. Hence, the channel 150B at the wavelength is dropped out at the port 120 while other channels λ₂ are exported at the port 140.

The module 100 may use the add port 130 and the filter 160 to add a new channel at the transmissive wavelength λ₂ of the filter 160 to the output 160A. This is accomplished by sending an input beam 130A at the wavelength λ₂ that carries the new channel into the WDM module 100. The beam 130A, after being collimated by the lens 132 and transmitting through the filter 160, is combined with the reflected beam 150A to form the final output beam 160A. If the input signal 110 does not have a channel at λ₂, the signal 130A will be added at λ₂; if the input signal 110A does have an input channel at λ₂, this input channel will be dropped by the filter 150 at the drop fiber port 120 and in exchange, the new channel 130A at λ₂ may be added. Therefore, the WDM element 100 is operable to add a WDM channel at λ₂ to the output fiber port 140 when the input beam 110A has a void at the wavelength λ₂, to drop an input WDM channel at λ₂, or to exchange the input channel at λ₂ with a new channel at λ₂ from the add fiber port 130.

The WDM add-drop module 100 may also include a variable optical attenuator 170 in the optical path of the signal 130A between the fiber port 130 and the filter 160, e.g., between the lens 132 and the filter 160 as shown. The power level of the signal 130A hence may be adjusted to a desired power level when being added to the signal 150A to form the WDM output signal 160A. The attenuator 170 may be an adjustable optical aperture such as an iris with a suitable geometry or a knife edge. In operation, the power level of the beam 130A is adjusted through a partial blocking of the beam 130A by the aperture 170. The position of the aperture 170 may be controlled either manually or automatically using an aperture control mechanism.

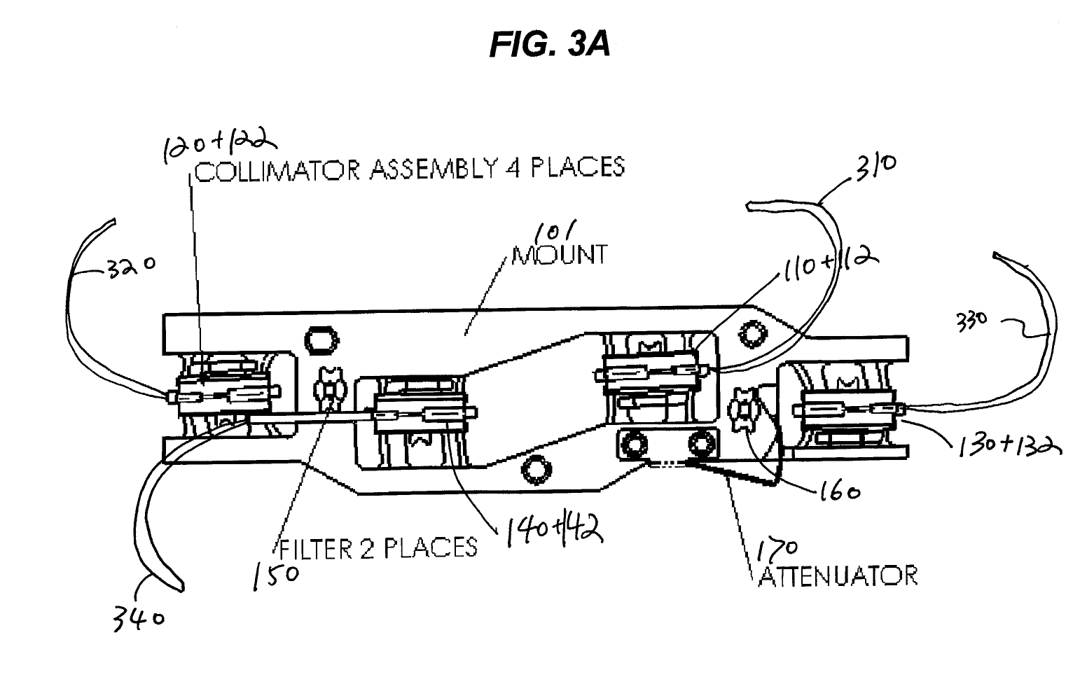

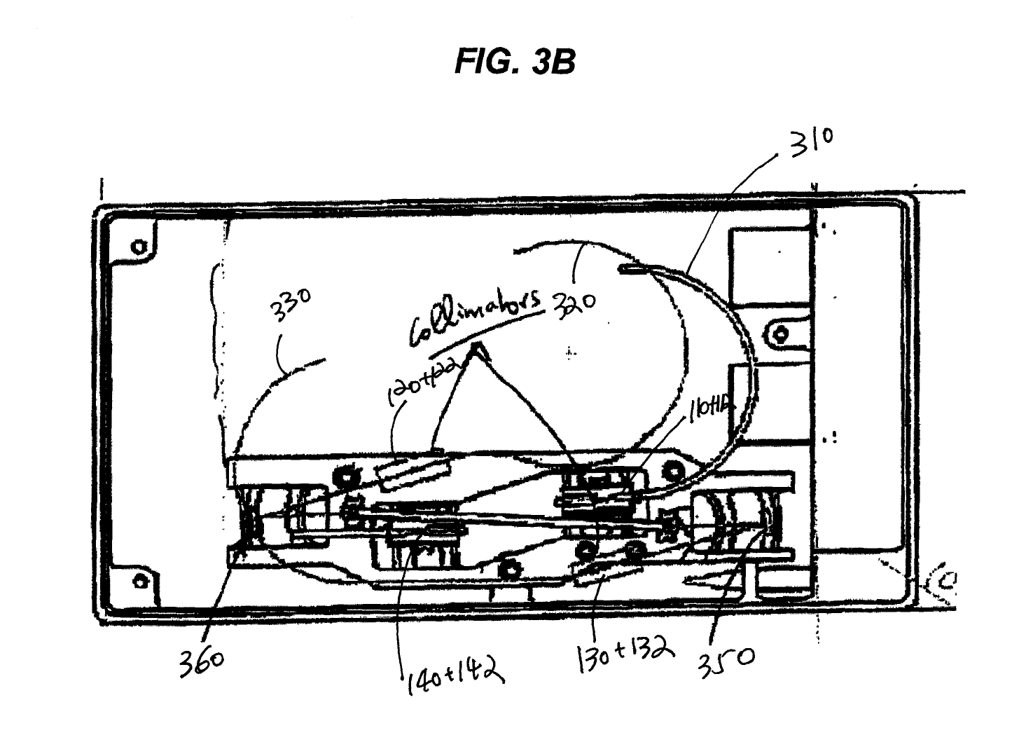

FIGS. 3A and 3B show two exemplary device implementations of the WDM module 100 in FIG. 1. The implementation in FIG. 3A essentially follows the layout of the device 100 in FIG. 1. When fibers 310, 320, 330, and 340 are coupled to the fiber ports 110, 120, 130, and 140, respectively, the fibers 310, 320, 330, and 340 may be bent or rolled into a loop to fit into the device package. A fiber, however, is known to leak optical energy when bent and the degree of leakage increases as the radius of the bent portion of the fiber decreases. Therefore, the radius of a bent portion of the fiber may be not be less than a minimum radius in order to maintain the optical loss below an acceptable level. This requirement places a lower limit in the physical size of the device.

The implementation shown in FIG. 3B takes the advantage of the freedom in directing light of the free-space optical layout within the device 100. Two optical reflectors 350 and 360 are used to change the directions of the beams 150B and 130A and relocate the positions of the fiber ports 120 and 130 along with their respective collimator lenses 122 and 132. Hence, when the positions of the fiber ports 120 and 130 are properly selected, the coupled fibers can be positioned to save space without compromising the requirement of the lower limit on the radius of the bent fibers. The use of reflectors 350 and 360 can increase the internal optical path lengths of the signals without increasing the internal optical loss of the device since both reflectors 350 and 360 may be made highly reflective and light propagation in free space essentially has no loss. In comparison, an increase in the optical path length in a bent fiber may significantly increase the optical loss due to the optical leakage in the bent fiber portions. In some implementations, the device implementation in FIG. 3B could save about 30% space in comparison with the device implementation in FIG. 3A and hence may be preferable when it is desirable to have a compact device.

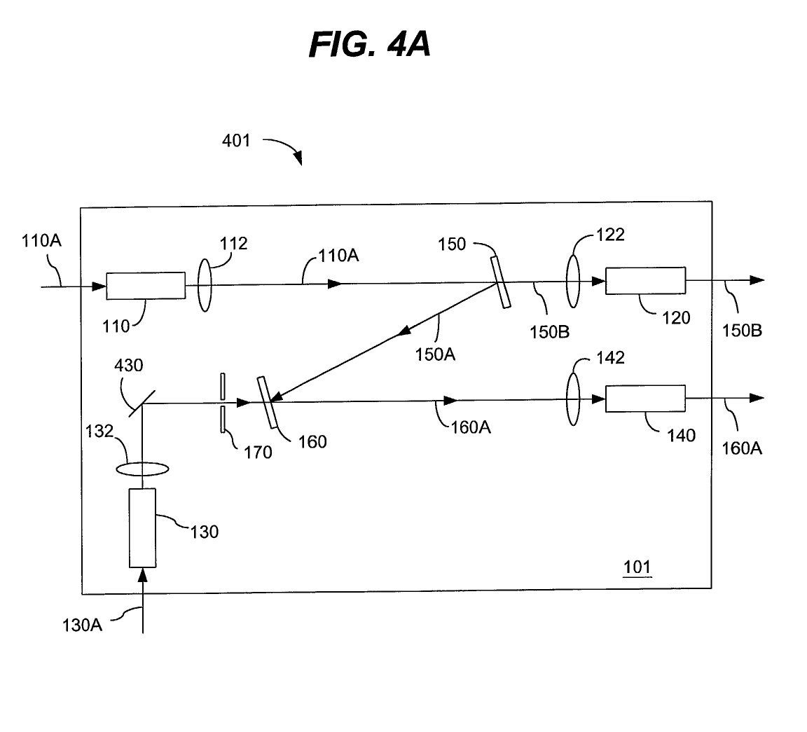

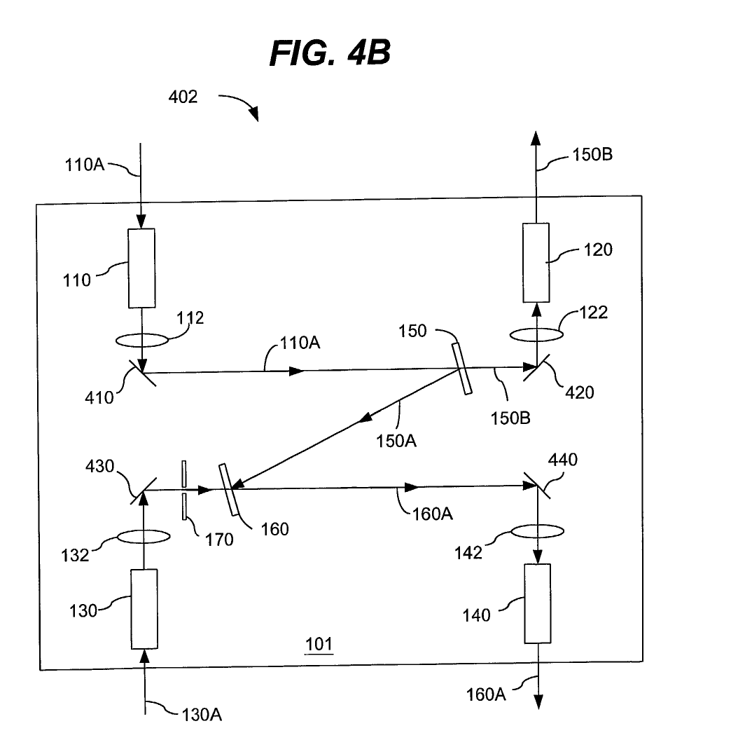

FIGS. 4A and 4B show two additional examples 401 and 402 where one or more reflectors may be used to place one or more fiber ports and their associated collimator lenses at suitable locations on the base 101 to either reduce the overall device size or facilitate the interface with an external fiber or fiber device. In FIG. 4A, a reflector 430 is used to relocate the add fiber port 130 and the lens 132. In FIG. 4B, four reflectors 410, 420, 430, and 440 are used to relocate all four fiber ports and their lenses.

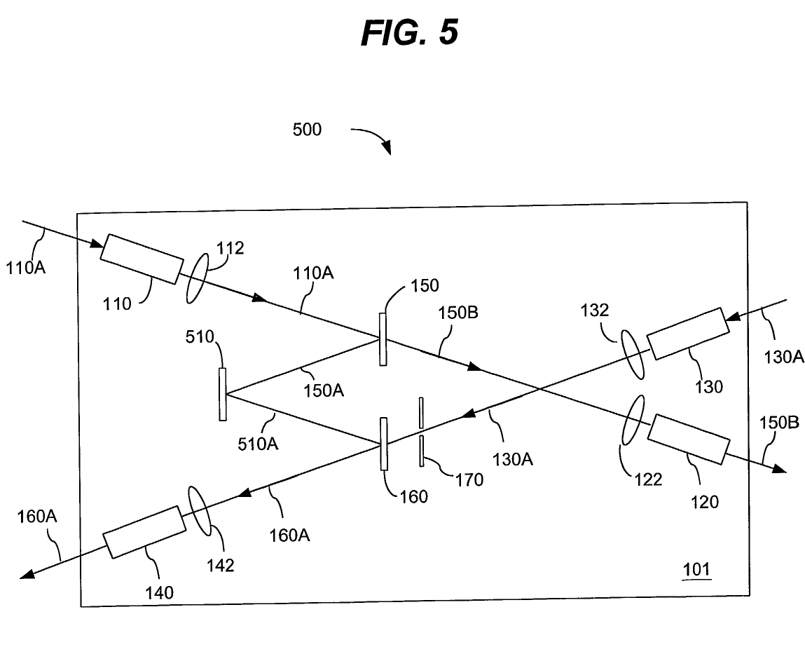

FIGS. 5, 6, and 7 respectively show embodiments of 4-port WDM add-drop modules 500, 600, and 700 that use three optical bandpass filters 150, 160, and 510. The filter 510 is configured in a similar design as the filters 150 and 160 and is operable to transmit the same selected transmissive wavelength and to reflect other wavelengths. The filter 510 is located in the optical path between the filters 150 and 160 to reflect the reflected beam 150A from the filter 150 as a beam 510A to the filter 160. The filter 160 then reflects the beam 510A one more time to direct it to the output fiber port 140. Hence, the reflected WDM channels in the input signal 110A are reflected three times when they reach the output fiber port 140 as a portion or the entirety of the output signal 160A.

Notably, the resultant spectrum after the three reflections is the product of the reflective spectra of the filters 150, 510, and 160. Hence, any residual signal from the dropped signal 150B at the filter 150 is further suppressed by optical reflections by the filters 510 and 160. Therefore, when a new channel at the dropped channel wavelength is added at the filter 160, the additional filter 510 improves the channel isolation between the dropped channel 150B and the added channel 130A. In principle, more than three filters may be used if additional suppression of the residual signal from the dropped channel is desired.

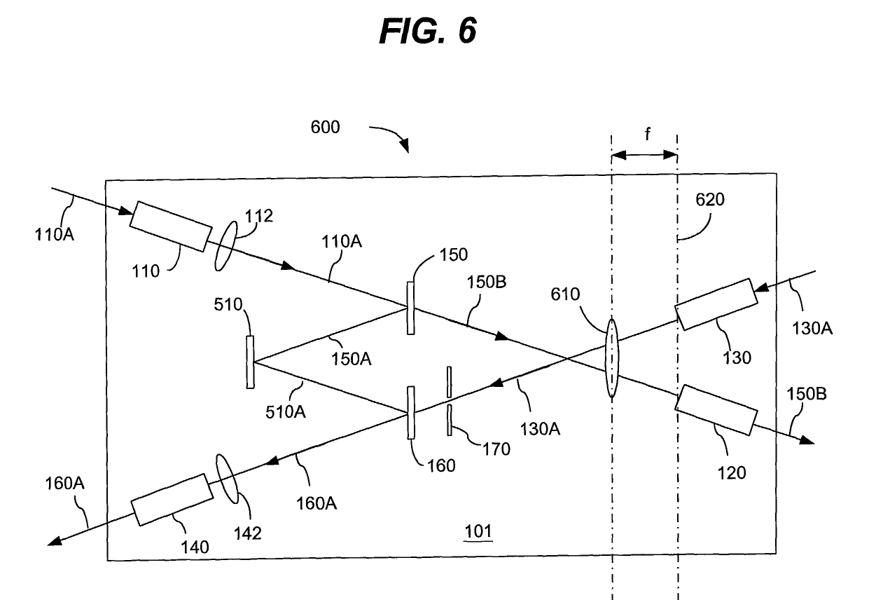

The presence of the third filter 510 in FIGS. 5 and 6 changes the optical arrangement of the two-filter systems in FIGS. 1, 3A, 3B, 4A, and 4B in which the two optical axes 101A and 101B are substantially parallel. In FIGS. 5 and 6, the optical axes 101A and 101B are no longer parallel but form an angle. When the three filters 150, 510, and 160 are substantially identical in their filter structures and hence filtering characteristics, they may be arranged relative to one another so that the incident angle of the beam 110A to the filter 150, the incident angle of the beam 150A to the filter 510, and the incident angle of the 510A to the filter 160 are substantially the same. Under this condition, the filter spectra of the three filters 150, 510, and 160 can substantially match at the selected transmissive wavelength. As illustrated in FIGS. 5 and 6, and 7, the beam 150B transmitting through the filter 150 for the dropped channel forms an angle with respect to the beam 130A for the added channel incident to the filter 160. Accordingly, the embodiments 500 and 600 in FIGS. 5 and 6 position the fiber ports 120 and 130 at the same relative angle with respect to each other. In FIG. 5, two separate collimator lenses 122 and 132 are respectively placed in front of the fiber ports 120 and 130. In FIG. 6, a common collimator lens 610 is used for collimation for both fiber ports 120 and 130. The facets of the fiber ports 120 and 130 are located in the focal plane 620 of the lens 610 and form the desired relative angle for proper optical coupling.

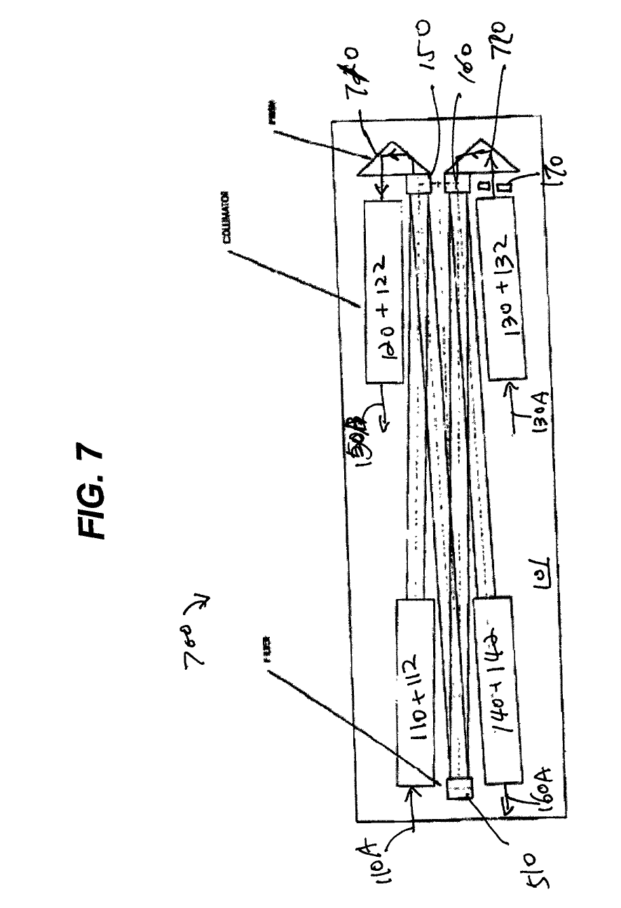

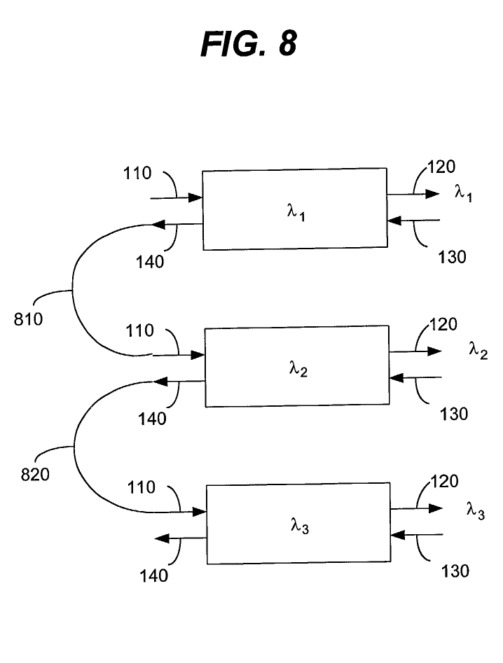

The embodiment 700 in FIG. 7 uses two prism reflectors 710 and 720 to direct the beams 150B and 130A so that the fiber ports 120, 130 and their respective collimator lenses 122 and 132 may be relocated on the base 101 to reduce the device size. Each prism reflector has two reflective surfaces to reflect a beam twice. Alternatively, two mirror reflectors may be used to replace the prism reflector. This scheme may also be used in the two-filter WDM add-drop devices shown in FIGS. 1 through 4B.

Two or more 4-port WDM add-drop modules based on any of the above embodiments or their variations may be used as building blocks to form a variety of WDM devices. FIG. 8 shows one exemplary WDM device that uses three different WDM modules at different wavelengths λ₁, λ₂, and λ₃, respectively. A fiber 810 is coupled to direct signals from the output fiber port 140 of the first WDM module at λ₁ into the input fiber port 110 of the second WDM module λ₂. Another fiber 820 is coupled to direct signals from the output fiber port 140 of the second WDM module λ₃ into the input fiber port 110 of the third WDM module λ₃. This device allows for dropping, adding, or exchanging any channels at the wavelengths λ₁, λ₂, and λ₃. In principle, any number of such WDM modules may be so combined to provide versatile operations for adding, dropping, or exchanging channels at different wavelengths.

Although the present disclosure only includes a few embodiments, other modifications and enhancements may be made without departing from the following claims.

What is claimed is:

1. A device, comprising:
a base;
a first optical bandpass filter fixed on said base and configured to receive an input optical signal with a plurality of wavelength-division multiplexed (WDM) channels and to transmit light at a transmission wavelength to produce a drop-channel beam while reflecting light at other wavelengths to produce a first reflected beam;
a second optical bandpass filter fixed on said base and spaced from said first optical bandpass filter to receive said first reflected beam through free space, said second optical bandpass filter configured to transmit light at said transmission wavelength and to reflect light at other wavelengths so as to reflect said first reflected optical beam as a second reflected optical beam, wherein said second optical bandpass filter is positioned to receive and transmit an add-channel beam at said transmission wavelength in free space to merge into said second reflected optical beam; and
an adjustable optical attenuator located on said base in a free-space optical path of said add-channel beam before entering said second optical bandpass filter and configured to adjust a power level of said add-channel beam.

2. The device as in claim 1, wherein said adjustable optical attenuator includes an adjustable optical aperture.

3. The device as in claim 1, further comprising:
an first fiber port and a first collimator lens mounted on said base to receive said input optical signal, said first collimator lens configured and positioned to collimate and direct said input optical signal to said first optical bandpass filter through free space;
a second fiber port and a second collimator lens mounted on said base, said second collimator lens configured and positioned to receive said drop-channel beam from said first optical bandpass filter through free space and direct said drop-channel beam into said second fiber port;
a third fiber port mounted on said base to receive said add-channel beam and a third collimator lens mounted on said base and positioned to direct said add-channel beam to said second optical bandpass filter through free space after collimation; and
a fourth fiber port and a fourth collimator lens mounted on said base, said fourth collimator lens positioned to receive said second reflected beam from said second optical bandpass filter through free space and couple said second reflected beam into said fourth fiber port.

4. The device as in claim 3, further comprising at least one optical reflector in an optical path of one of said input optical signal, said add-channel beam, said drop-channel beam, and said second reflected optical beam, wherein said optical reflector is positioned to change a direction of said one beam.

5. The device as in claim 4, wherein said at least one optical reflector includes a prism reflector.

6. A device, comprising:
a base;
a first optical bandpass filter fixed on said base and configured to receive an input optical signal with a plurality of wavelength-division multiplexed (WDM) channels and to transmit light at a transmission wavelength to produce a drop-channel beam while reflecting light at other wavelengths to produce a first reflected beam;
a second optical bandpass filter fixed on said base and spaced from said first optical bandpass filter to receive said first reflected beam through free space, said second optical bandpass filter configured to transmit light at said transmission wavelength and to reflect light at other wavelengths so as to reflect said first reflected optical beam as a second reflected optical beam, wherein said second optical bandpass filter is positioned to receive and transmit an add-channel beam at said transmission wavelength in free space to merge into said second reflected optical beam;
a third optical bandpass filter fixed on said base in a free-space optical path of said first reflected optical beam between said first and said second optical bandpass filters and configured to transmit light at said transmission wavelength and to reflect light at other wavelengths so as to reflect and direct said first reflected optical beam to said second optical bandpass filter; and
an adjustable optical attenuator located on said base in a free-space optical path of said add-channel beam before entering said second optical bandpass filter and configured to adjust a power level of said add-channel beam.

7. The device as in claim 6, wherein said adjustable optical attenuator includes an adjustable optical aperture.

8. The device as in claim 6, further comprising:
an first fiber port and a first collimator lens mounted on said base to receive said input optical signal, said first collimator lens configured and positioned to collimate and direct said input optical signal to said first optical bandpass filter through free space;
a second fiber port and a second collimator lens mounted on said base, said second collimator lens configured and positioned to receive said drop-channel beam from said first optical bandpass filter through free space and direct said drop-channel beam into said second fiber port;
a third fiber port mounted on said base to receive said add-channel beam and a third collimator lens mounted on said base and positioned to direct said add-channel beam to said second optical bandpass filter through free space after collimation; and
a fourth fiber port and a fourth collimator lens mounted on said base, said fourth collimator lens positioned to receive said second reflected beam from said second optical bandpass filter through free space and couple said second reflected beam into said fourth fiber port.

9. The device as in claim 8, further comprising at least one optical reflector in an optical path of one of said input optical signal, said add-channel beam, said drop-channel beam, and said second reflected optical beam, wherein said optical reflector is positioned to change a direction of said one beam.

10. The device as in claim 9, wherein said at least one optical reflector includes a prism reflector.

11. The device as in claim 6, further comprising:
an input fiber port and an input collimator lens mounted on said base to receive said input optical signal, said input collimator lens configured and positioned to collimate and direct said input optical signal to said first optical bandpass filter through free space;
a drop fiber port mounted on said base to receive said drop-channel beam from said first optical bandpass filter;
an add fiber port mounted on said base to receive said add-channel beam to be directed to said second optical bandpass filter through free space;
a common collimator lens mounted on said base in an interception of optical paths of said drop-channel beam and said add-channel beam to couple said drop-channel beam into said drop fiber port and to collimate and direct said add-channel beam to said second optical bandpass filter;
an output fiber port and an output collimator lens mounted on said base, said output collimator lens positioned to receive said second reflected beam from said second optical bandpass filter through free space and direct said second reflected beam into said output fiber port.

12. The device as in claim 11, further comprising at least one optical reflector in an optical path of one of said input optical signal, said add-channel beam, said drop-channel beam, and said second reflected optical beam, wherein said optical reflector is positioned to change a direction of said one beam.

13. A method, comprising:
using optical fibers to receive an input optical signal with a plurality of wavelength-division multiplexed (WDM) channels and an add-channel beam at a selected wavelength and to export an output optical signal with output WDM channels and a drop-channel beam at said selected wavelength;
using at least two optical bandpass filters to process said input optical signal and said add-channel beam in free space to produce said output signal and said drop-channel beam so that optical loss associated processing and transporting optical signals in optical fibers is avoided, wherein each optical bandpass filter is configured to transmit light at said selected wavelength and to reflect light at other wavelengths; and
attenuating said add-channel beam in free space to control a power level of said add-channel beam in said output signal.

14. The method as in claim 13, further comprising using at least one optical reflector to change a direction of at least one optical beam in free space so that one of said optical fibers is located to reduce a package space while maintaining a bent portion of said one fiber with a minimum radius of curvature.

15. The method as in claim 13, wherein one optical bandpass filter is used to receive said input optical signal to produce a first reflected signal and to transmit light at said selected wavelength to produce said drop-channel beam, and said second bandpass filter is used to reflect said first reflected optical signal to produce a second reflected optical signal and to receive said add-channel beam in a direction of said second reflected signal to merge said add-channel beam and said second reflected signal together as said output signal.

16. The method as in claim 15, further comprising using a third optical bandpass filter in a free-space optical path between said first and said second optical bandpass filters to reduce a signal in said output signal at said selected wavelength that was originally present in said input optical signal.

17. The method as in claim 13, wherein said attenuating of said add-channel beam is implemented by using an adjustable optical aperture in the free-space optical path of said add-channel beam prior to entry of one of said two optical bandpass filters.

18. A device, comprising:
a plurality of WDM modules, each WDM module configured to have an input fiber port, an output fiber port, an add fiber port, and a drop fiber port and to add or drop a WDM channel at a selected wavelength different from selected wavelengths that are added or dropped in other WDM modules; and
optical fibers respectively connecting said output fiber port of one WDM module to said input fiber port of another WDM module of said WDM modules so that a WDM optical signal with WDM channels is directed through each of said WDM modules in sequence by entering each WDM module from its input fiber port and exiting from its output fiber port,
wherein each WDM module comprises:
a base;
a first optical bandpass filter fixed on said base and configured to receive an input optical signal with WDM channels from said input fiber port and to transmit light at a transmission wavelength to produce a drop-channel beam into said drop fiber port while reflecting light at other wavelengths to produce a first reflected beam,
a second optical bandpass filter fixed on said base and spaced from said first optical bandpass filter to receive said first reflected beam through free space, said second optical bandpass filter configured to transmit light at said transmission wavelength and to reflect light at other wavelengths so as to reflect said first reflected optical beam as a second reflected optical beam, wherein said second optical bandpass filter is positioned to receive and transmit an add-channel beam at said transmission wavelength in free space from said add fiber port to merge into said second reflected optical beam into said output fiber port, and
an adjustable optical attenuator located on said base in a free-space optical path of said add-channel beam before entering said second optical bandpass filter and configured to adjust a power level of said add-channel beam.

19. The device as in claim 18, further comprising at least one optical reflector in an optical path of one of said input optical signal, said add-channel beam, said drop-channel beam, and said second reflected optical beam, wherein said optical reflector is positioned to change a direction of said one beam.

20. The device as in claim 18, further comprising at least one optical reflector in an optical path of one of said input optical signal, said add-channel beam, said drop-channel beam, and said second reflected optical beam, wherein said optical reflector is positioned to change a direction of said one beam.
